(19) United States
(12) Patent Application Publication
(10) Pub. No.: US 2015/0299239 A1
(43) Pub. Date: Oct. 22, 2015

(54) NOVEL TRIDENTATE COMPLEXES AND PROCESS OF PRODUCING POLYCARBONATE BY COPOLYMERIZATION OF CARBON DIOXIDE AND EPOXIDE USING THE SAME AS CATALYST

(71) Applicants: SK INNOVATION CO., LTD., Seoul (KR); SK GLOBAL CHEMICAL CO, LTD., Seoul (KR)

(72) Inventors: Cyriac ANISH, Daejeon (KR); So Hee SIM, Daejeon (KR); Myung Ahn OK, Daejeon (KR); Ji Su JEONG, Daejeon (KR); Il Gu JUNG, Daejeon (KR); Jeon Koo LEE, Daejeon (KR); Sujith SUDEVAN, Daejeon (KR); Kyung Yeon KANG, Daejeon (KR); Jeong Hyun NOH, Daejeon (KR); Sung Jae NA, Daejeon (KR)

(21) Appl. No.: 14/344,176

(22) PCT Filed: Jan. 21, 2014
(86) PCT No.: PCT/KR2014/000595

§ 371 Date: Mar. 11, 2014

(30) Foreign Application Priority Data
Jan. 28, 2013 (KR) 10-2013-0009119

(51) Int. Cl. C07F 15/06; C08G 64/34

(52) U.S. Cl. CPC C07F 15/065; C08G 64/34

(57) ABSTRACT

Provided are a complex synthesized from a novel tridentate ligand including an ammonium salt and a process of producing polycarbonate by copolymerization of carbon dioxide and epoxide using the same as a catalyst. A novel tridentate complex may be cheaply prepared as compared to the existing tetradentate complex containing four ammonium salts but have an advantage in that the novel tridentate complex may have an activity at a level similar to that of the existing tetradentate complex by adopting a cis-β conformation. Further, since in the tridentate complex, the number of ammonium salt serving as an initiator is small but the number of vacant sites is large as compared to the tetradentate complex containing four ammonium salts, the tridentate complex may have excellent activity.

### TECHNICAL FIELD

The present invention relates to complexes synthesized from a novel tridentate ligand containing an ammonium salt and a process of producing a polycarbonate by copolymerization of carbon dioxide and an epoxide compound using the same as a catalyst.

### BACKGROUND ART

Aliphatic polycarbonate, which is an easily biodegradable polymer, is a useful raw material, for example, as a packing material or a coating material. A process of producing a polycarbonate from an epoxide compound and carbon dioxide has eco-friendly high value in that phosgene, which is a toxic compound, is not used, and carbon dioxide may be cheaply obtained.

Since the 1960s, many researchers have developed various types of catalysts in order to prepare the polycarbonate from the epoxide compound and carbon dioxide. A high activity and selectivity catalyst synthesized from a recently developed salen ([H₂Salen=N,N′-bis(3,5-dialkylsalicylidene)-1,2-ethylenediamine]-type ligand containing a quaternary ammonium salt may have high activity and high selectivity, prepare a copolymer having a large molecular weight, and perform polymerization at a high temperature, such that the catalyst may be applied to a commercial process. In addition, since the catalyst includes the quaternary ammonium salt in the ligand, there is an advantage in that the catalyst may be easily separated from a copolymer after a carbon dioxide/epoxide copolymerization reaction to thereby be reused [Bunyeol Lee, Korean Patent Registration No. 10-0853358 (Registration Date: Aug. 13, 2008); Bunyeol Lee, Sujith S, Eungyeong No, Jaegi Min, Korean Patent Registration No. 10-0981270 (Registration Date: Sep. 3, 2010); Bunyeol Lee, Sujith S, Eungyeong No, Jaegi Min, WO08/136591 (Open Date: Nov. 13, 2008); Eun Kyung Noh, Sung Jae Na, Sujith S, Sang-Wook Kim, and Bun Yeoul Lee* J. Am. Chem. Soc. 2007, 129, 8082-8083 (Jul. 4, 2007); Sujith S., Jae Ki Min, Jong Eon Seong, Sung Jea Na, and Bun Yeoul Lee, Angew. Chem. Int Ed., 2008, 47, 7306-7309 (Sep. 8, 2008)].

In addition, it was found that among catalyst groups disclosed in the above-mentioned Patent Documents, a catalyst particularly having high activity and high selectivity as compared to other catalysts has a unique structure in which a nitrogen atom of the salen-ligand is not coordinated, but only an oxygen atom is coordinated to a metal, which was not known in the art (See the following Structure 1, Sung Jae Na, Sujith S., Anish Cyriac, Bo Eun Kim, Jina Yoo, Youn K. Kang, Su Jung Han, Chongmok Lee, and Bun Yeoul Lee* “Elucidation of the Structure of A Highly Active Catalytic System for CO₂/Epoxide Copolymerization: A Salen-Cobaltate Complex of An Unusual Binding Mode” Inorg. Chem. 2009, 48, 10455-10465).

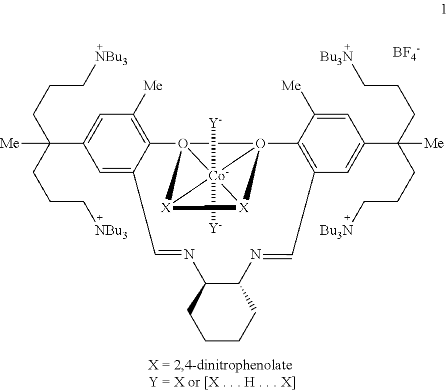

Further, a method capable of easily synthesizing a ligand of the compound was developed (Min, J.; Seong, J. E.; Na, S. J.; Cyriac, A.; Lee, B. Y. Bull. Korean Chem. Soc. 2009, 30, 745-748). However, in consideration of injecting a high activity catalyst having the Structure 1 into a commercial process, there are problems as follows:

1) 2,4-dinitrophenolate or 2,4-dinitrophenol included in the catalyst of Structure 1 is known as an explosive material. Particularly, 2,4-dinitrophenolate or 2,4-dinitrophenol is known to be more explosive in the absence of moisture (K. R. Desai, B. G. Naik, Production of Organic Intermediates (Pharmaceutical and Dyestuff), Sarup & Sons, New Delhi, 2005; p 5). The catalyst of Structure 1 should be prepared and stored under conditions at which moisture is not present. Therefore, the catalyst is not suitable for being mass produced and continuously used.

2) When carbon dioxide/epoxide copolymerization is carried out using the catalyst of Structure 1, a polymer chain grows from 2,4-dinitrophenolate or 2,4-dinitrophenol included in the catalyst of Structure 1. That is, a 2,4-dinitrophenol group is attached to the ends of most of the polymer chains. That is, in a catalyst recovering step, 2,4-dinitrophenolate or 2,4-dinitrophenol are not recovered. The 2,4-dinitrophenol group is attached to the ends of all of the polymer chains, which is a cause of increasing a cost of the resin. In addition, a 2,4-dinitrophenol anion is considerably yellow colored, and the resin may be light yellow colored even after removing the catalyst. 3) Since the catalyst of Structure 1 includes four ammonium salts, a manufacturing cost is high.

### DISCLOSURE

### Technical Problem

In order to solve the problem as described above, the present inventors studied and found that a tridentate complex with a cis-β conformation may be cheaply prepared as compared to the existing tetradentate complex containing four ammonium salts (Korean Patent Registration No. 10-0853358 and Korean Patent Laid-Open Publication No. 10-2010-0013255) and has more vacant sites capable of activating a monomer to thereby have an activity at a level similar to that of the existing complex, thereby completing the present invention.

An object of the present invention is to provide a complex synthesized from a novel tridentate ligand containing an ammonium salt.

Another object of the present invention is to provide a process of producing polycarbonate by copolymerization of carbon dioxide and an epoxide compound using the complex as a catalyst.

### Technical Solution

In one general aspect, there is provided a complex represented by the following Chemical Formula 1:

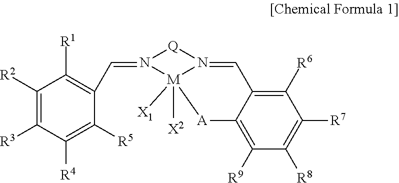

In Chemical Formula 1,

M is trivalent cobalt or trivalent chromium;

A is an oxygen or sulfur atom;

Q is a diradical linking two nitrogen atoms;

R¹ to R⁹ are each independently hydrogen; halogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; (C6-C20)aryl(C1-C20)alkyl containing at least one selected from halogen, nitrogen, oxygen, silicon, sulfur, and phosphorus; (C1-C20)alkoxy; (C6-C30)aryloxy; formyl; (C1-C20)alkylcarbonyl; (C6-C20)arylcarbonyl; or —[CR¹⁰₃₋ₘ{(CR¹¹R¹²)ₙY⁺R¹³R¹⁴R¹⁵}ₘ(Z⁻)ₘ], two of R¹ to R⁹ being linked to each other to form a ring;

at least one of R¹ to R⁹ is —[CR¹⁰₃₋ₘ{(CR¹¹R¹²)ₙY⁺R¹³R¹⁴R¹⁵}ₘ(Z⁻)ₘ];

Y is nitrogen or phosphorus;

R¹⁹ to R¹⁵ are each independently hydrogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; or (C6-C20)aryl(C1-C20)alkyl containing at least one selected from halogen, nitrogen, oxygen, silicon, sulfur, and phosphorus; two of R¹³, R¹⁴, and R¹⁵ being linked to each other to form a ring;

m is an integer of 1 to 3;

n is an integer of 1 to 20; and

X¹, X², and Z are each independently a halide ion; BF₄⁻; ClO₄⁻; NO₃⁻; PF₆⁻; HCO₃⁻; (C6-C30)aryloxy anion; (C6-C30)aryloxy anion containing at least one selected from halogen, nitrogen, oxygen, silicon, sulfur, and phosphorus; (C1-C20)alkylcarboxylate anion; (C1-C20)alkylcarboxylate anion containing at least one selected from halogen, nitrogen, oxygen, silicon, sulfur, and phosphorus; (C6-C20)arylcarboxylate anion; (C6-C20)arylcarboxylate anion containing at least one selected from halogen, nitrogen, oxygen, silicon, sulfur, and phosphorus; (C1-C20)alkoxy anion; (C1-C20)alkoxy anion containing at least one selected from halogen, nitrogen, oxygen, silicon, sulfur, and phosphorus; (C1-C20)alkylcarbonate anion; (C1-C20)alkylcarbonate anion containing at least one selected from halogen, nitrogen, oxygen, silicon, sulfur, and phosphorus; (C6-C20)arylcarbonate anion; (C6-C20)arylcarbonate anion containing at least one selected from halogen, nitrogen, oxygen, silicon, sulfur, and phosphorus; (C1-C20)alkylsulfonate anion; (C1-C20)alkylsulfonate anion containing at least one selected from halogen, nitrogen, oxygen, silicon, sulfur, and phosphorus; (C6-C20)arylsulfonate anion; (C6-C20)arylsulfonate anion containing at least one selected from halogen, nitrogen, oxygen, silicon, sulfur, and phosphorus; (C1-C20)alkylamido anion; (C1-C20)alkylamido anion containing at least one selected from halogen, nitrogen, oxygen, silicon, sulfur, and phosphorus; (C6-C20)arylamido anion; (C6-C20)arylamido anion containing at least one selected from halogen, nitrogen, oxygen, silicon, sulfur, and phosphorus; (C1-C20)alkylcarbamate anion; (C1-C20)alkylcarbamate anion containing at least one selected from halogen, nitrogen, oxygen, silicon, sulfur, and phosphorus; (C6-C20)arylcarbamate anion; or (C6-C20)arylcarbamate anion containing at least one selected from halogen, nitrogen, oxygen, silicon, sulfur, and phosphorus.

In Chemical Formula 1, Q may be (C6-C30)arylene, (C1-C20)alkylene, (C2-C20)alkenylene, (C2-C20)alkynylene, or (C3-C20)cycloalkylene.

In Chemical Formula 1, M may be trivalent cobalt;

A may be oxygen;

Q may be trans-1,2-cyclohexylene, phenylene, or ethylene;

R¹ to R⁸ may be each independently hydrogen; halogen; (C1-C20)alkyl; (C2-C20)alkenyl; (C1-C20)alkyl(C6-C20)aryl; (C6-C20)aryl(C1-C20)alkyl; (C1-C20)alkoxy; (C6-C30)aryloxy; formyl; (C1-C20)alkylcarbonyl; (C6-C20)arylcarbonyl, or —[CR¹⁸₃₋ₘ{(CR¹¹R¹²)ₙY⁺R¹³R¹⁴R¹⁵}ₘ(Z⁻)ₘ];

Y may be nitrogen or phosphorus;

R¹⁰ to R¹⁵ may be each independently hydrogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; or (C6-C20)aryl(C1-C20)alkyl; (C6-C20)aryl(C1-C20)alkyl containing at least one selected from halogen, nitrogen, oxygen, silicon, sulfur, and phosphorus; two of R¹³, R¹⁴, and R¹⁵ being linked to each other to form a ring;

m may be an integer of 1 to 3;

n may be an integer of 1 to 20; and

R⁹ may be methyl or ethyl.

The complex of Chemical Formula 1 may be a complex represented by the following Chemical Formula 2:

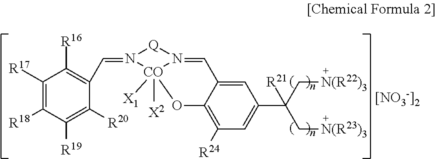

In Chemical Formula 2,

Q may be trans-1,2-cyclohexylene, phenylene, or ethylene;

R¹⁶ to R²⁰ may be each independently hydrogen; halogen; (C1-C20)alkyl; (C2-C20)alkenyl; (C1-C20)alkoxy; two of R¹⁶ to R²⁰ may be linked to each other to form a ring;

R²¹ to R²³ may be each independently hydrogen or (C1-C6)alkyl;

R²⁴ may be methyl or ethyl;

n may be an integer of 1 to 20;

X¹ and X² may be each independently halogen anion; NO₃⁻; (C6-C30)aryloxy anion; (C6-C30)aryloxy anion containing at least one selected from halogen, nitrogen, oxygen, silicon, sulfur, and phosphorus; (C1-C20)alkylcarboxylate anion; or (C1-C20)alkylcarboxylate anion containing at least one selected from halogen, nitrogen, oxygen, silicon, sulfur, and phosphorus; and

X¹ and X² coordinated to cobalt may be linked to each other via monodentate or bidentate.

In the complex resprented by Chemical Formula 2, Q may be trans-1,2-cyclohexylene;

R¹⁶ to R²⁰

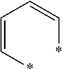 [SMILES: */C=C\C=C/*]

may be each independently hydrogen, methyl, t-butyl, or methoxy, or may be linked to a substituent adjacent thereto via C4 alkenylene ( ) to form an aromatic ring;

R²¹ may be hydrogen or methyl;

R²² and R²³ may be butyl;

R²⁴ may be methyl or ethyl;

n may be 3; and

X¹ and X² may be each independently acetate or 4-nitrophenolate.

In another general aspect, there is provided a process of producing a polycarbonate including copolymerizing an epoxide compound and carbon dioxide using the complex represented by Chemical Formula 1 as a catalyst.

The epoxide compound may be at least one selected from a group consisting of (C2-C20)alkyleneoxide substituted or unsubstituted with halogen, (C1-C20)alkyloxy, (C6-C20)aryloxy, or (C6-C20)aryl(C1-C20)alkyloxy; (C4-C20)cycloalkyleneoxide substituted or unsubstituted with halogen, (C1-C20)alkyloxy, (C6-C20)aryloxy, or (C6-C20)aryl(C1-C20)alkyloxy; and (C8-C20)styreneoxide substituted or unsubstituted with halogen, (C1-C20)alkyloxy, (C6-C20)aryloxy, (C6-C20)aryl(C1-C20)alkyloxy, or (C1-C20)alkyl.

### Advantageous Effects

In the complex synthesized from the novel tridentate ligand containing an ammonium salt, which has a cis-β conformation, the number of initiators is small as compared to the existing tetradentate complex containing four ammonium salts, but the number of vacant sites capable of activating a monomer is larger, such that the complex may have an excellent activity. In addition, the tridentate complex according to the present invention may be cheaply prepared as compared to the existing tetradentate complex to thereby have high economical efficiency.

Further, a high purity polycarbonate may be prepared by copolymerizing carbon dioxide and the epoxide compound using the tridentate complex according to the present invention as the catalyst.

### MODE FOR INVENTION

In one general aspect, the present invention provides a complex synthesized from a novel tridentate ligand containing an ammonium salt, more particularly, a complex represented by the following Chemical Formula 1.

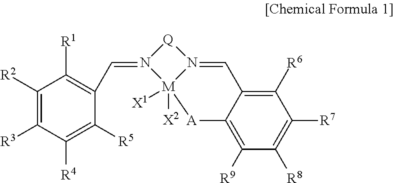

In Chemical Formula 1,

M is trivalent cobalt or trivalent chromium;

A is an oxygen or sulfur atom;

Q is a diradical linking two nitrogen atoms;

R¹ to R⁹ are each independently hydrogen; halogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; (C6-C20)aryl(C1-C20)alkyl containing at least one selected from halogen, nitrogen, oxygen, silicon, sulfur, and phosphorus; (C1-C20)alkoxy; (C6-C30)aryloxy; formyl; (C1-C20)alkylcarbonyl; (C6-C20)arylcarbonyl; or —[CR¹⁰₃₋ₘ{(CR¹¹R¹²)ₙY⁺R¹³R¹⁴R¹⁵}ₘ(Z⁻)ₘ]; two of R¹ to R⁹ being linked to each other to form a ring;

at least one of R¹ to R⁹ is —[CR¹⁰₃₋ₘ{(CR¹¹R¹²)ₙY⁺R¹³R¹⁴R¹⁵}ₘ(Z⁻)ₘ];

Y is nitrogen or phosphorus;

R¹⁹ to R¹⁵ are each independently hydrogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; or (C6-C20)aryl(C1-C20)alkyl containing at least one selected from halogen, nitrogen, oxygen, silicon, sulfur, and phosphorus; two of R¹³, R¹⁴, and R¹⁵ being linked to each other to form a ring;

m is an integer of 1 to 3;

n is an integer of 1 to 20; and

X¹, X², and Z are each independently a halide ion; BF₄⁻; ClO₄⁻; NO₃⁻; PF₆⁻; HCO₃⁻; (C6-C30)aryloxy anion; (C6-C30)aryloxy anion containing at least one selected from halogen, nitrogen, oxygen, silicon, sulfur, and phosphorus; (C1-C20)alkylcarboxylate anion; (C1-C20)alkylcarboxylate anion containing at least one selected from halogen, nitrogen, oxygen, silicon, sulfur, and phosphorus; (C6-C20)arylcarboxylate anion; (C6-C20)arylcarboxylate anion containing at least one selected from halogen, nitrogen, oxygen, silicon, sulfur, and phosphorus; (C1-C20)alkoxy anion; (C1-C20)alkoxy anion containing at least one selected from halogen, nitrogen, oxygen, silicon, sulfur, and phosphorus; (C1-C20)alkylcarbonate anion; (C1-C20)alkylcarbonate anion containing at least one selected from halogen, nitrogen, oxygen, silicon, sulfur, and phosphorus; (C6-C20)arylcarbonate anion; (C6-C20)arylcarbonate anion containing at least one selected from halogen, nitrogen, oxygen, silicon, sulfur, and phosphorus; (C1-C20)alkylsulfonate anion; (C1-C20)alkylsulfonate anion containing at least one selected from halogen, nitrogen, oxygen, silicon, sulfur, and phosphorus; (C6-C20)arylsulfonate anion; (C6-C20)arylsulfonate anion containing at least one selected from halogen, nitrogen, oxygen, silicon, sulfur, and phosphorus;(C1-C20)alkylamido anion; (C1-C20)alkylamido anion containing at least one selected from halogen, nitrogen, oxygen, silicon, sulfur, and phosphorus; (C6-C20)arylamido anion; (C6-C20)arylamido anion containing at least one selected from halogen, nitrogen, oxygen, silicon, sulfur, and phosphorus; (C1-C20)alkylcarbamate anion; (C1-C20)alkylcarbamate anion containing at least one selected from halogen, nitrogen, oxygen, silicon, sulfur, and phosphorus; (C6-C20)arylcarbamate anion; or (C6-C20)arylcarbamate anion containing at least one selected from halogen, nitrogen, oxygen, silicon, sulfur, and phosphorus.

The tridentate complex according to the present invention, which is a complex synthesized from the tridentate ligand, adopts a cis-β conformation as shown below, such that the number of ammonium salts is small as compared to the existing tetradentate complex containing four ammonium salts, but the tridentate complex may have the activity at a level similar to that of the tetradentate complex.

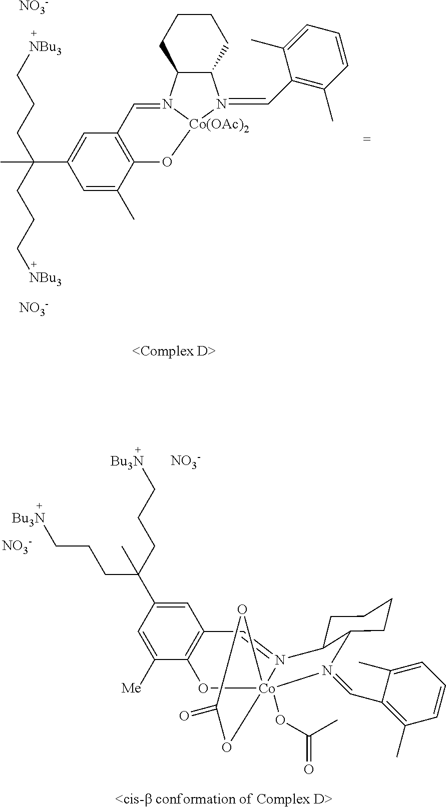

In Chemical Formula 1, Q is (C6-C30)arylene, (C1-C20)alkylene, (C2-C20)alkenylene, (C2-C20)alkynylene, or (C3-C20)cycloalkylene. Preferably, in Chemical Formula 1,M is trivalent cobalt; A is oxygen; Q is trans-1,2-cyclohexylene, phenylene, or ethylene; R¹ to R⁸ are each independently hydrogen; halogen; (C1-C20)alkyl; (C2-C20)alkenyl; (C1-C20)alkyl(C6-C20)aryl; (C6-C20)aryl(C1-C20)alkyl; (C1-C20)alkoxy; (C6-C30)aryloxy; formyl; (C1-C20)alkylcarbonyl; (C6-C20)arylcarbonyl, or —[CR¹⁰₃₋ₘ{(CR¹¹R¹²)ₙY⁺R¹³R¹⁴R¹⁵}ₘ(Z⁻)ₘ]; Y is nitrogen or phosphorus; R¹⁰ to R¹⁵ are each independently hydrogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; or (C6-C20)aryl(C1-C20)alkyl containing at least one selected from halogen, nitrogen, oxygen, silicon, sulfur, and phosphorus; two of R¹³, R¹⁴, and R¹⁵ being linked to each other to form a ring; m is an integer of 1 to 3; n is an integer of 1 to 20; and R⁹ is methyl or ethyl.

More preferably, the complex of Chemical Formula 1 may be a complex of Chemical Formula 2.

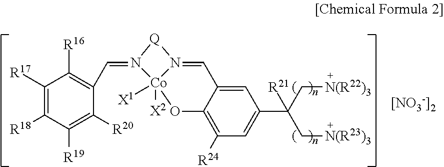

In Chemical Formula 2,

Q is trans-1,2-cyclohexylene, phenylene, or ethylene;

R¹⁶ to R²⁰ are each independently hydrogen; halogen; (C1-C20)alkyl; (C2-C20)alkenyl; (C1-C20)alkoxy; two of R¹⁶ to R²⁰ being linked to each other to form a ring;

R²¹ to R²³ are each independently hydrogen or (C1-C6)alkyl;

R²⁴ is methyl or ethyl;

n is an integer of 1 to 20;

X¹ and X² are each independently halogen anion; NO₃⁻; (C6-C30)aryloxy anion; (C6-C30)aryloxy anion containing at least one selected from halogen, nitrogen, oxygen, silicon, sulfur, and phosphorus; (C1-C20)alkylcarboxylate anion; or (C1-C20)alkylcarboxylate anion containing at least one selected from halogen, nitrogen, oxygen, silicon, sulfur, and phosphorus; and

X¹ and X² coordinated to cobalt may be linked to each other via monodentate or bidentate.

More preferably, in Chemical Formula 2, Q is trans-1,2-cyclohexylene; R¹⁶ to R²⁰

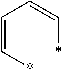 [SMILES: */C=C\C=C/*]

are each independently hydrogen, methyl, t-butyl, or methoxy, or may be linked to a substituent adjacent thereto via C4 alkenylene ( ) to form an aromatic ring; R²¹ may be hydrogen or methyl; R²² and R²³ are butyl; R²⁴ is methyl or ethyl; n is 3; and X¹ and X² are each independently acetate or 4-nitrophenolate.

In another general aspect, there is provided a process of producing a polycarbonate including copolymerizing an epoxide compound and carbon dioxide using the complex of Chemical Formula 1 as a catalyst. The epoxide compound may be at least one selected from a group consisting of (C2-C20)alkyleneoxide substituted or unsubstituted with halogen, (C1-C20)alkyloxy, (C6-C20)aryloxy, or (C6-C20)aryl(C1-C20)alkyloxy; (C4-C20)cycloalkyleneoxide substituted or unsubstituted with halogen, (C1-C20)alkyloxy, (C6-C20)aryloxy, or (C6-C20)aryl(C1-C20)alkyloxy; and (C8-C20)styreneoxide substituted or unsubstituted with halogen, (C1-C20)alkyloxy, (C6-C20)aryloxy, (C6-C20)aryl(C1-C20)alkyloxy, or (C1-C20)alkyl. An example of the aryloxy may include phenoxy, biphenyloxy, naphthyloxy, and the like. The alkyloxy, aryloxy, arylalkyloxy and alkyl may have a substituent selected from halogen atoms and (C1-C20)alkoxy groups.

Specific examples of the epoxide compound may include ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxide norbornene, limonene oxide, dieldrin, 2,3-epoxidepropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxidepropyl ether, epoxypropyl methoxyphenyl ether, biphenyl glycidyl ether, glycidyl naphthyl ether, and the like.

The epoxide compound may be used in polymerization using an organic solvent as a reaction medium, and as an example of the solvent, one of aliphatic hydrocarbons such as pentane, octane, decane, cyclohexane, and the like, aromatic hydrocarbons such as benzene, toluene, xylene, and the like, and halogenated hydrocarbons such as chloromethane, methylene chloride, chloroform, carbon tetrachloride, 1,1-dichloroethane, 1,2-dichloroethane, ethyl chloride, trichloroethane, 1-chloropropane, 2-chloropropane, 1-chlorobutane, 2-chlorobutane, 1-chloro-2-methylpropane, chlorobenzene, bromobenzene, and the like, may be used alone, or a combination of at least two thereof may be used. More preferably, bulk polymerization using a monomer itself as a solvent may be performed.

A molar ratio of the epoxide compound to the catalyst (that is, epoxide compound: catalyst) may be in a range of 1,000 to 1,000,000, preferably, 2,000 to 200,000. In this case, a conversion rate of the catalyst, that is, the number of moles of the epoxide compound consumed based on 1 mol cobalt or chromium per time may be 200 or more turnover/hr. In the copolymerizing, a pressure of carbon dioxide may be in a range of atmospheric pressure up to 100 atm, preferably 5 to 30 atm. In the copolymerizing, a polymerization temperature may be in a range of 20 to 120° C., preferably 50 to 90° C.

The polycarbonate may be polymerized by a batch polymerization method, a semi-batch polymerization method, or a continuous polymerization method. In the case of using the batch polymerization method or semi-batch polymerization method, a reaction time may be 1 to 24 hours, preferably 1.5 to 4 hours. In the case of using the continuous polymerization method, it is preferable that an average residence time of the catalyst may also be 1.5˜4 hours.

According to the present invention, a polycarbonate having a number average molecular weight (Mₙ) of 5,000 to 1,000,000 and a molecular weight distribution (that is, M_{w}/Mₙ) of 1.05 to 4.0 may be prepared. Here, Mₙ indicates a number average molecular weight determined by using polystyrene having a single molecular weight distribution as a standard and then measuring its molecular weight by gel permeation chromatography (GPC), and M_{w}/Mₙ is a ratio of a weight average molecular weight measured by GPC using the same method to the number average molecular weight.

A prepared polycarbonate polymer is composed of 80% or more of carbonate bonds, and frequently 95% or more of carbonate bonds. The polycarbonate prepared according to the present invention, which is an easily biodegradable polymer having neither residue nor soot at the time of combustion, is a useful material, for example as a packaging material, a heat-insulating material, or a coating material.

In the following Example, an effect of the present invention will be described in detail. The following examples are provided for illustrative purposes, but are not limited to the scope of the present invention.

### EXAMPLE 1

### Synthesis of Catalyst (Compound D)

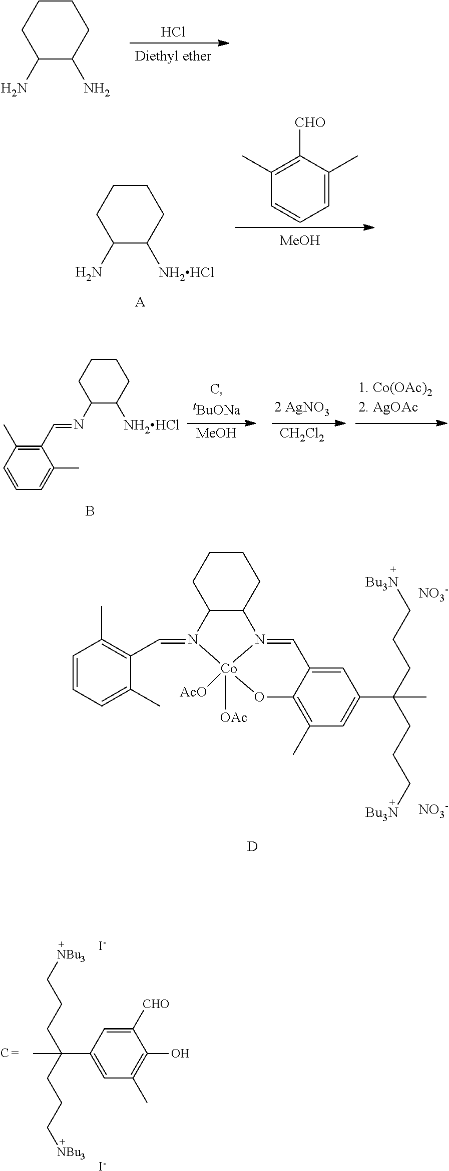

Synthesis of Compound A

trans-1,2-Diaminocyclohexane (1.00 g, 8.76 mmol) was put into a flask and dissolved by adding 10 mL of diethyl ether thereto, and then HCl (1 M in diethyl ether, 8.76 mL) was slowly added thereto. The mixture was stirred for 4 hours, and a slurry solution was filtered, thereby removing the solvent. The obtained solid was washed with diethyl ether (3×10 mL), and then a solvent was removed under reduced pressure, thereby obtaining Compound A (quantitative yield).

¹H NMR (DMSO-d₆, 500 MHz): δ 5.25 (br, 5H, NH₂, NH₂.HCl), 2.29 (br, 2H N—CH), 1.68 (br, 2H, CH₂), 1.42 (br, 2H, CH₂), 0.99 (br, 4H, CH₂) ppm.

Synthesis of Compound B

Compound A (0.500 g, 3.33 mmol) and 2,6-dimethylbenzaldehyde (0.447 g, 3.33 mmol) were put into a flask and dissolved by adding 10 mL of methanol. The resultant was stirred for 4 hours, and a solvent was removed under reduced pressure, thereby obtaining Compound B (quantitative yield).

¹H NMR (DMSO-d₆, 500 MHz): δ 8.73 (s, 1H, CH=N), 8.06 (br, 3H NH₃Cl), 7.20 (m, 1H, p-H), 7.08 (m, 2H, m-H), 3.33 (br, 1H, cyclohexyl N—CH), 3.19 (br, 1H, cyclohexyl N—CH), 2.41 (s, 6H, Ar—CH₃), 2.10 (br, 1H, cyclohexyl CH₂), 1.76 (br, 3H, cyclohexyl CH₂), 1.62 (br, 1H, cyclohexyl CH₂), 1.45-1.38 (br, 3H, cyclohexyl CH₂) ppm.

Synthesis of Complex D

Compound A (0.500 g, 1.87 mmol) and Compound C (1.63 g, 1.87 mmol) were put into a flask and dissolved by adding 20 mL of methanol under nitrogen atmosphere. Compound C was synthesized by the known method (Bull. Korean Chem. Soc. 2009, 30, 745-748). Sodium tert-butoxide (0.186 g, 1.92 mmol) were slowly added thereto and stirred for 4 hours, followed by removal of a solvent under reduced pressure. After 10 mL of methylene chloride was added thereto to dissolve the resultant and then filtered to remove NaCl, AgNO₃ (0.633 g, 3.74 mmol) was added to the filtered solution. Light was blocked and the mixture was stirred for 5 hours, followed by filtering, thereby removing AgI. After cobalt acetate (Co(OAc)₂, 0.331 g, 1.87 mmol) was added to the filtered solution and stirred for 4 hours, silver acetate (AgOAc, 0.312 g, 1.87 mmol) was added thereto. After light was blocked and the mixture was stirred for 4 hours, the mixture was filtered to thereby remove a solvent, thereby obtaining Complex D (quantitative yield) as a brown solid.

¹H NMR (CD₂Cl₂, 500 MHz): δ 8.64-8.47 (m, 2H, CH=N), 7.40-6.85 (m, 5H, Ar—H), 7.08 (m, 2H, m-H), 3.13 (br, 18H, N—CH₂, cyclohexyl-N—CH), 2.27 (s, 3H, Ar—CH₃), 2.22 (s, 3H, Ar—CH₃), 2.06 (s, 3H, Ar—CH₃) 1.9-1.2 (br, 49H, CH₂, cyclohexyl-CH₂, CH₃, acetate-CH₃), 0.97 (br, 18H, CH₃) ppm.

### EXAMPLE 2

### Copolymerization of Carbon Dioxide/Propylene Oxide

Complex D (0.080 g, propylene oxide/catalyst=2,000) prepared in Example 1 and propylene oxide (10.0 g, 172 mmol) were put into a 50 mL bomb reactor under nitrogen atmosphere, and then the reactor was assembled. After carbon dioxide gas having a pressure of 25 bars was applied to the reactor, the reactor was dipped into an oil bath in which a temperature was controlled in advance to 60° C. and stirred. After 50 minutes, it was observed that the pressure of carbon dioxide gas was decreased, and a polymerization reaction was carried out for 2 hours after the reaction started. After the reactor was dipped into a cooling bath to thereby be cooled, the reaction was terminated by removing carbon dioxide gas. 20.0 g of propylene oxide was further added into the obtained viscous solution to lower viscosity of the solution, and then was passed through a silica gel (400 mg, Merc Company, 0.040 to 0.063 mm particle size (230 to 400 meshes)) column, thereby removing the catalyst. Propylene oxide was completely removed by vacuum decompression, thereby obtaining a white solid (2.5 g). This yield corresponds to an activity with a turnover number (TON) of 285 and a turnover frequency (TOF) of 142.5 h⁻¹. The selectivity for polypropylene carbonate as compared to propylene carbonate was calculated by analyzing ¹H NMR spectrum, and as a result, the selectivity was 83%.

### INDUSTRIAL APPLICABILITY

In the complex synthesized from the novel tridentate ligand containing an ammonium salt, which has a cis-β conformation, the number of initiators is small as compared to the existing tetradentate complex containing four ammonium salts, but the number of vacant sites capable of activating a monomer is larger, such that the complex may have an excellent activity. In addition, the tridentate complex according to the present invention may be cheaply prepared as compared to the existing tetradentate complex to thereby have high economical efficiency.

Further, a high purity polycarbonate may be prepared by copolymerizing carbon dioxide and the epoxide compound using the tridentate complex according to the present invention as the catalyst.

1. A complex represented by the following Chemical Formula 1: 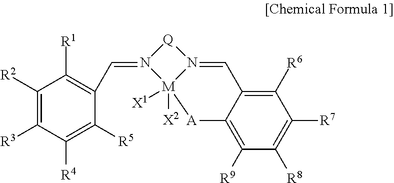
In Chemical Formula 1,
M is trivalent cobalt or trivalent chromium;
A is an oxygen or sulfur atom;
Q is a diradical linking two nitrogen atoms;
R¹ to R⁹ are each independently hydrogen; halogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; (C6-C20)aryl(C1-C20)alkyl containing at least one selected from halogen, nitrogen, oxygen, silicon, sulfur, and phosphorus; (C1-C20)alkoxy; (C6-C30)aryloxy; formyl; (C1-C20)alkylcarbonyl; (C6-C20)arylcarbonyl; —[CR¹⁰₃₋ₘ{(CR¹¹R¹²)ₙY⁺R¹³R¹⁴R¹⁵}ₘ(Z⁻)ₘ], two of R¹ to R⁹ being linked to each other to form a ring;
at least one of R¹ to R⁹ is —[CR¹⁰₃₋ₘ{(CR¹¹R¹²)ₙY⁺R¹³R¹⁴R¹⁵}ₘ(Z⁻)ₘ];
Y is nitrogen or phosphorus;
R¹⁰ to R¹⁵ are each independently hydrogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; or (C6-C20)aryl(C1-C20)alkyl containing at least one selected from halogen, nitrogen, oxygen, silicon, sulfur, and phosphorus; two of R¹³, R¹⁴, and R¹⁵ being linked to each other to form a ring;
m is an integer of 1 to 3;
n is an integer of 1 to 20; and
X¹, X², and Z are each independently a halide ion; BF₄⁻; ClO₄⁻; NO₃⁻; PF₆⁻; HCO₃⁻; (C6-C30)aryloxy anion; (C6-C30)aryloxy anion containing at least one selected from halogen, nitrogen, oxygen, silicon, sulfur, and phosphorus; (C1-C20)alkylcarboxylate anion; (C1-C20)alkylcarboxylate anion containing at least one selected from halogen, nitrogen, oxygen, silicon, sulfur, and phosphorus; (C6-C20)arylcarboxylate anion; (C6-C20)arylcarboxylate anion containing at least one selected from halogen, nitrogen, oxygen, silicon, sulfur, and phosphorus; (C1-C20)alkoxy anion; (C1-C20)alkoxy anion containing at least one selected from halogen, nitrogen, oxygen, silicon, sulfur, and phosphorus; (C1-C20)alkylcarbonate anion; (C1-C20)alkylcarbonate anion containing at least one selected from halogen, nitrogen, oxygen, silicon, sulfur, and phosphorus; (C6-C20)arylcarbonate anion; (C6-C20)arylcarbonate anion containing at least one selected from halogen, nitrogen, oxygen, silicon, sulfur, and phosphorus; (C1-C20)alkylsulfonate anion; (C1-C20)alkylsulfonate anion containing at least one selected from halogen, nitrogen, oxygen, silicon, sulfur, and phosphorus; (C6-C20)arylsulfonate anion; (C6-C20)arylsulfonate anion containing at least one selected from halogen, nitrogen, oxygen, silicon, sulfur, and phosphorus;(C1-C20)alkylamido anion; (C1-C20)alkylamido anion containing at least one selected from halogen, nitrogen, oxygen, silicon, sulfur, and phosphorus; (C6-C20)arylamido anion; (C6-C20)arylamido anion containing at least one selected from halogen, nitrogen, oxygen, silicon, sulfur, and phosphorus; (C1-C20)alkylcarbamate anion; (C1-C20)alkylcarbamate anion containing at least one selected from halogen, nitrogen, oxygen, silicon, sulfur, and phosphorus; (C6-C20)arylcarbamate anion; or (C6-C20)arylcarbamate anion containing at least one selected from halogen, nitrogen, oxygen, silicon, sulfur, and phosphorus.

2. The complex of claim 1, wherein Q is (C6-C30)arylene, (C1-C20)alkylene, (C2-C20)alkenylene, (C2-C20)alkynylene, or (C3-C20)cycloalkylene.

3. The complex of claim 2, wherein in Chemical Formula 1,
M is trivalent cobalt;
A is oxygen;
Q is trans-1,2-cyclohexylene, phenylene, or ethylene;
R¹ to R⁸ are each independently hydrogen; halogen; (C1-C20)alkyl; (C2-C20)alkenyl; (C1-C20)alkyl(C6-C20)aryl; (C6-C20)aryl(C1-C20)alkyl; (C1-C20)alkoxy; (C6-C30)aryloxy;
formyl; (C1 -C20)alkylcarbonyl; (C6-C20)arylcarbonyl, or —[CR¹⁰₃₋ₘ{(CR¹¹R¹²)ₙY⁺R¹³R¹⁴R¹⁵}ₘ(Z⁻)ₘ];
Y is nitrogen or phosphorus;
R¹⁰ to R¹⁵ are each independently hydrogen; (C1-C20)alkyl; (C1-C20)alkyl containing at least one selected from halogen, nitrogen, oxygen, silicon, sulfur, and phosphorus; (C2-C20)alkenyl; (C2-C20)alkenyl containing at least one selected from halogen, nitrogen, oxygen, silicon, sulfur, and phosphorus; (C1-C20)alkyl(C6-C20)aryl; (C1-C20)alkyl(C6-C20)aryl containing at least one selected from halogen, nitrogen, oxygen, silicon, sulfur, and phosphorus; (C6-C20)aryl(C1-C20)alkyl; or (C6-C20)aryl(C1-C20)alkyl containing at least one selected from halogen, nitrogen, oxygen, silicon, sulfur, and phosphorus; two of R¹³, R¹⁴, and R¹⁵ being linked to each other to form a ring;
m is an integer of 1 to 3;
n is an integer of 1 to 20; and
R⁹ is methyl or ethyl.

4. The complex of claim 3, wherein it is represented by the following Chemical Formula 2: 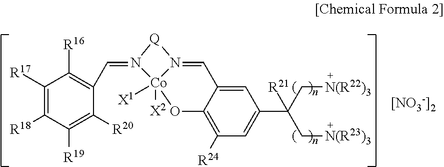
In Chemical Formula 2,
Q is trans-1,2-cyclohexylene, phenylene, or ethylene;
R¹⁶ to R²⁰ are each independently hydrogen; halogen; (C1-C20)alkyl; (C2-C20)alkenyl; (C1-C20)alkoxy; two of R¹⁶ to R²⁰ are linked to each other to form a ring;
R²¹ to R²³ are each independently hydrogen or (C1-C6)alkyl;
R²⁴ is methyl or ethyl;
n is an integer of 1 to 20;
X¹ and X² are each independently halogen anion; NO₃⁻; (C6-C30)aryloxy anion; (C6-C30)aryloxy anion containing at least one selected from halogen, nitrogen, oxygen, silicon, sulfur, and phosphorus; (C1-C20)alkylcarboxylate anion; or (C1-C20)alkylcarboxylate anion containing at least one selected from halogen, nitrogen, oxygen, silicon, sulfur, and phosphorus; and
X¹ and X² coordinated to cobalt is linked to each other via monodentate or bidentate.

5. The complex of claim 4, wherein in Chemical Formula 2,
Q is trans-1,2-cyclohexylene;
R¹⁶ to R²⁰ are each independently hydrogen, methyl, t-butyl, or methoxy, or are linked to a substituent adjacent thereto via C4 alkenylene 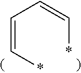 [SMILES: */C=C\C=C/*]
to form an aromatic ring;
R²¹ is hydrogen or methyl;
R²² and R²³ are butyl;
R²⁴ is methyl or ethyl;
n is 3; and
X¹ and X² are each independently acetate or 4-nitrophenolate.

6. A process of producing a polycarbonate comprising copolymerizing an epoxide compound and carbon dioxide using the complex of claim 1 as a catalyst.

7. The process of producing a polycarbonate of claim 6, wherein the epoxide compound is at least one selected from a group consisting of (C2-C20)alkyleneoxide substituted or unsubstituted with halogen, (C1-C20)alkyloxy, (C6-C20)aryloxy, or (C6-C20)aryl(C1-C20)alkyloxy; (C4-C20)cycloalkyleneoxide substituted or unsubstituted with halogen, (C1-C20)alkyloxy, (C6-C20)aryloxy, or (C6-C20)aryl(C1-C20)alkyloxy; and (C8-C20)styreneoxide substituted or unsubstituted with halogen, (C1-C20)alkyloxy, (C6-C20)aryloxy, (C6-C20)aryl(C1-C20)alkyloxy, or (C1-C20)alkyl.

8. A process of producing a polycarbonate comprising copolymerizing an epoxide compound and carbon dioxide using the complex of claim 3 as a catalyst.

9. The process of producing a polycarbonate of claim 8, wherein the epoxide compound is at least one selected from a group consisting of (C2-C20)alkyleneoxide substituted or unsubstituted with halogen, (C1-C20)alkyloxy, (C6-C20)aryloxy, or (C6-C20)aryl(C1-C20)alkyloxy; (C4-C20)cycloalkyleneoxide substituted or unsubstituted with halogen, (C1-C20)alkyloxy, (C6-C20)aryloxy, or (C6-C20)aryl(C1-C20)alkyloxy; and (C8-C20)styreneoxide substituted or unsubstituted with halogen, (C1-C20)alkyloxy, (C6-C20)aryloxy, (C6-C20)aryl(C1-C20)alkyloxy, or (C1-C20)alkyl.

10. A process of producing a polycarbonate comprising copolymerizing an epoxide compound and carbon dioxide using the complex of claim 4 as a catalyst.

11. The process of producing a polycarbonate of claim 10, wherein the epoxide compound is at least one selected from a group consisting of (C2-C20)alkyleneoxide substituted or unsubstituted with halogen, (C1-C20)alkyloxy, (C6-C20)aryloxy, or (C6-C20)aryl(C1-C20)alkyloxy; (C4-C20)cycloalkyleneoxide substituted or unsubstituted with halogen, (C1-C20)alkyloxy, (C6-C20)aryloxy, or (C6-C20)aryl(C1-C20)alkyloxy; and (C8-C20)styreneoxide substituted or unsubstituted with halogen, (C1-C20)alkyloxy, (C6-C20)aryloxy, (C6-C20)aryl(C1-C20)alkyloxy, or (C1-C20)alkyl.
